(19) United States
(12) Patent Application Publication
(10) Pub. No.: US 2013/0126005 A1
(43) Pub. Date: May 23, 2013

(54) METHOD OF ULTRASONIC CAVITATION TREATMENT OF LIQUID MEDIUM

(71) Applicants: Andrej Getalov, Moscow (RU); Evgeny Dedyukhin, Kazan (RU); Marat Giniyatullin, Kazan (RU); Aleksandr Sirotkin, Kazan (RU)

(72) Inventors: Andrej Getalov, Moscow (RU); Evgeny Dedyukhin, Kazan (RU); Marat Giniyatullin, Kazan (RU); Aleksandr Sirotkin, Kazan (RU)

(21) Appl. No.: 13/813,495

(22) PCT Filed: Sep. 21, 2011
(86) PCT No.: PCT/RU11/00719

§ 371 Date: Jan. 31, 2013

(51) Int. Cl. F17D 1/00

(52) U.S. Cl. CPC F17D 1/00
USPC 137/13

(57) ABSTRACT

The subject invention refers to the field of cavitation treatment of liquid medium as well as the medium having the density of water or other liquid phase exceeds 65-70% of total mass. Method of ultrasonic cavitation treatment of liquid medium is what the mode of acoustic cavitation is being simultaneously generated on two or several different frequencies, at that the mechanical vibration system—channel with rectangular cross-section, is made in the form of tandem membranes having different frequencies of fundamental harmonic of vibrations, generating of acoustic vibrations with formation of standing wave is performed in phase over against the channel, that in turn generate quasi-plane standing waves, corresponding with vibrations frequencies of the membranes, in the channel clearance. This method allows to upgrade the power and amplitude of acoustic wave, coherence) cavitation influence to the treated liquid medium and the bodies place in this medium with the simultaneous limitation of power of ultrasonic sources.

The present invention refers to the field of cavitation treatment f liquid medium as well as the medium having the density of water or other liquid body is more than 65-70% of total mass. It is known that acoustic ultrasonic cavitation can be leveraged in different fields of economy implementing the following technological process /1-6/:
Dispergating;
Homogeneization and emulsionizing;
Intermixing;
Disintegration;
Deagglomeration

As a matter of practice it covers process of producing of multicomponent medium(emulsions, suspensions, aqueous solutions and systems), ultrasonic sterilization (antisepsis) of water, milk, other liquid products e.t.c.

Method of treatment of liquid medium, being implemented in the scheme of the ultrasonic reactor can be taken as prototype/1/. This method consists in that the ultrasonic wave in liquid volume is generated by means of the rod reactor, in the abuting end of which there is a wave source usually being piezoelectric radiator.

There are a lot of variants of estimation of the form of rod radiator and the possibility of mounting of several piezoelectric radiators in its abuting end, but they all are focused on brightening vibrations of the rod in the bottom abuting end and on the sideboards/8/.

This is due to the fact that the zone of super cavitation in practice is measured by size in few centimeters from the surface of vibration. For this reason the but end of the rod is considered the most effective zone since conjunctional wave in the treated liquid is being formed between the flat abuting end of the radiator and the flat bottom. With that it should be noted that it is very difficult to make the diameter of the abuting end equal to the size more than 50-70 mm

The radiation from cylindrical surface of the rod has substantially smaller vibrational amplitude and cylindrical divergence. Factored in the acoustic waves reflected from external cylinder body walls it can be estimated that it is not practically possible to obtain the optimum condition of standing plane coherent ultrasonic wave in the treated liquid medium by analogy with the nonthreatening field between abuting end of the radiating unit and the bottom of the cylinder body.

Multiplex pattern of transmitted and reflected ultrasonic waves in the mediume, the absence of wave coherence and energy concentration at a single frequency lead to the fact that it is not practically possible to obtain emulsions with the size of dispersion phase less than ˜1.0 mkm, the homogeneity gauge is not in excess of 20% in the dominant mode. Thereat, the volume of the treated liquid is limited.

Another alternating method of ultrasonic cavitation treatment of liquid medium is put into practice in rotor-oscillatory

It is realized in rotor-pulsing homogenizers/2/.

By means of periodically generated alternating motion of the fluid from the rotary system stator-rotor, in insonation camera ultrasonic wave bearing cavitation effects originates. This is an interim option between acoustic and hydrodynamic cavitation. At the present moment such homogenizers gain the maximal currency. They are unsophisticated enough, take the opportunity to treat substantial volume of liquid much more cheaper than ultrasonic analogues. Satisfactory fast-speed homogenizers take the opportunity to obtain emulsions with the size of dispersion phase ˜1.5 mkm in the dominant mode, the homogeneity gauge is not in excess of 12-15%. Nevertheless this method also has a number of essential restrictions due to poor coefficient of efficiency of electromechanical system (up to 10%) that sets a limit to the power of ultrasonic wave to 1.5-2 watt/square centimetre, not taking the opportunity to work upon viscous medium and treatment of static liquid volume (volume stator-rotor) as well as a quite a number of other significant limitations.

The nearest equivalent method is the method of obtaining of emulsion cosmetic preparation according to Application No. 2010137176 of Sep. 8, 2010, the positive decision of ROSPATENT of Mar. 22, 2011r, No. 2010137176/ 15(052870).

Brightening of vibrational amplitude of acoustic wave in the treated liquid medium is effected by resonance cophasal vibrations of each bigger side of channel system having rectangular cross-section and additional superposition of waves inside the channel, at that inside distance is equal to the small side of channel and is multiple of quarter of acoustic wave length in the treated mediume. It takes the opportunity to centralize maximum energy on resonant vibrational frequency of the bigger side of the channel and obtain a standing acoustic wave of high intensity inside the channel.

The research carried out by the company “ DERMANIKA” indicated that dominant mode of dispercity in such process of treatment can be ˜500 nanometers and less, the emulsion does not practically include dispersion phase with the dimensions more than 1000 nanometers (1 micron), the proportion of emulsifier in the emulsion is twice or thrice less than usual. At that rotor-pulsing homogenizers take an opportunity to obtain emulsions with the dimensions of disperse phase beginning from 1000 nanometers (1 micron) and more with the more proportion of emulsifier/2/.

These research was fragmentary reported at the XIV International Research and Practice conference “Cosmetic preparations and raw materials:safety and efficiency” hold on in October 2009, where it was taken second place and the diploma, there are also publications in specialized magazines/6/.

In such a case the quality of products upgrades in accordance with cavitation criteria (cavitation threshold) [3,4] and resonant mode of operation with the maximum efficiency and the best key figures on intensification of integrated physical-chemical, hydromechanical, heat-exchanging and mass-exchanging processes to the treated medium and the minimum size and homogeneity of oil phase (fat phase) recovered in the output.

This technology is implemented in commercial size in the acting cosmetic manufacturer “Closed Joint Stock Company Laboratory EMANSI”. Initial products produced according to this technological process is the hand cream Anti Smell Smoke (for smokers, against influence of nicotine and smoke to hand skin) passed the total cycle of certification tests (Protocol of sanitary and healthcare inspection No77.01.12.915.Π.006156.02.10 of Feb. 3, 2010) and [symbol] statement of compliance confirmed by independent trails in laboratory “Spectrum”( accreditation certificate No ROSS RU.0001.21PSH50) with the corresponding test sheet No. 19 of Dec. 22, 2009.

However this technology has a number of limitations on use (for example, if it is used for treatment of items put into liquid medium, where acoustic waves are generated). In practice the gap width between the walls of the channel, provided it is required to obtain high intensity, should not be more than half-wavelength . In case the medium is water, it corresponds with the dimension ˜3.4 cm for the frequency 22 khz. Besides, it has been noted at various times that cavitation effects amplify in case the liquid is treated on two various friquencies

In the project /7, page.60/ it is indicated that “in the process of simultaneous impact of ultrasonic waves of two different frequencies (22-44 khz) it can be seen significant amplification of cavitation efficiency, that is much more stronger than the obtained while line summing up of the impact of each field of different vertical frequency”.
In the trials the author also got practical results and the main dependencies of two frequencies influence to obtaining various emulsions (cosmetic emulsions, mayonnaise, ketchup e.t.c.)

The aim of invention is efficiency upgrading (the power and amplitude of acoustic wave, coherence) cavitation influence to the treated liquid medium with the simultaneous limitation of power of ultrasonic sources.

This aim is accomplished by the fact that the conditions of acoustic cavitation is being simultaneously on two or several different frequencies, at the same time the mechanical vibration system—channel having rectangular cross-section, is made in the shape of tandem diaphragms having different frequencies of fundamental harmonic of vibrations, generating of acoustic vibration with forming of standing wave is effected in-phase over against the channel, that in turn, form quasi-plane standing waves corresponding with the frequencies of membranes vibrations in the clearance of channel borders, here the channel clearance h is taken divisible by quarter-wavelength, exited in this treated liquid mediume for the applied frequencies:

h=(k/4)*(C/f i), k=1,2,3,
where
fi—frequencies of fundamental harmonic of standing wave of the channel membranes,hz;
C—acoustic velocity in the liquid mediume, mps;
h—channel clearance, m;
it is required the vibration amplitude of channel boarder is to be fitted optimum for different stages of treatment of liquid medium and exceeds a threshold of acoustic cavitation.

In the designated methode there used the conception of concurrent treatment of the liquid by different frequiencies.

Presumable /3,7 and others./, the cavitation on high frequencies generates seeds in the liquid further augmenting under low frequency acoustic effect at the level of single cavitation bubble. This is achieved by the maximum quantity of bubbles and the power of each of them.

It is on record that membranes, as against plates, do not bear bending stiffness having higher frequencies of their own vibrations. The vibration frequency of a membranes, as against plates, does not depend on its gauge. The particular operation mode of the membrane-plate depends on the variety of factors such as the conditions of fixating at the edges (tension), inflection, the frequency of impact e.t.c. ./11/.

For the rectangular membrane with the fixed edges the solution of wave propagation after the setting of natural vibration frequencies to a fixed Cartesian coordinate system is given by/9,10/:

$$ω = c \sqrt{{k}_{x}^{2} + {k}_{y}^{2}} = c \sqrt{{( {j}_{x} \frac{π}{{L}_{x}} )}^{2} + {( {j}_{y} \frac{ω}{{L}_{y}} )}^{2}} ,$$

where c—the velocity of the waves over the plate;
kₓ, k_{y}—wave numbers, the value of which is defined by boundary conditions;
Lₓ, —lateral plate length, axially directed Ox;
L_{y}—lateral plate length, axially directed Oy;
jₓ, j_{y}—a whole number being equal to the number of antinodes lengthwise the corresponding sides of the plate.

For obtaining peak recoil from the membrane it is required to implement the mode of vibration on the first mode, when the number of antinodes is equal to 1 in both coordinate directions. In this case all points of the membrane oscillate on the same frequency and phase with the maximum deflection in the center of the membrane.

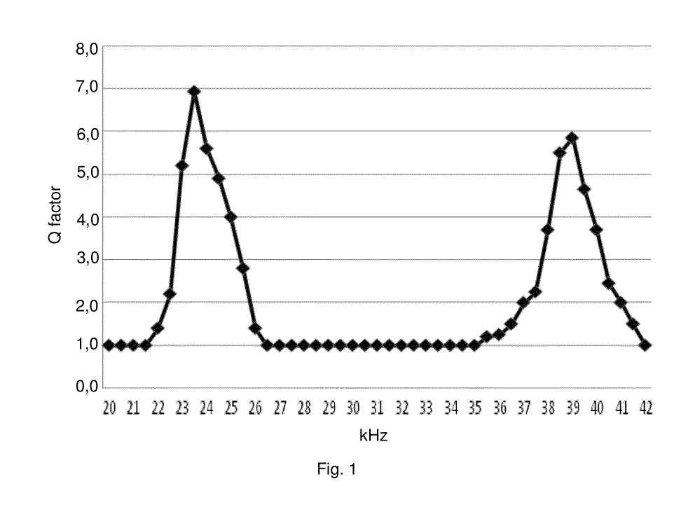

In FIG. 1 it is represented typical resonance characterization of vibration system—channel with rectangular cross-section made in the shape of alternate membranes.

It can be seen that on resonance frequency ˜23.2 khz the Q factor of the vibration spool-system is ˜7. It takes the opportunity substantially to enhance the vibration amplitude of acoustic wave in the liquid, touching with this surface, at that the power delivered to piezo-radiation source is not more than ˜50 Watt

The second membrane is turned to the frequency ˜40 khz, with Q factor ˜6. The power delivered to piezo-radiation source also is not more than 50 Watt, that is 2-2.5 as little, than while treating liquid at one frequency.

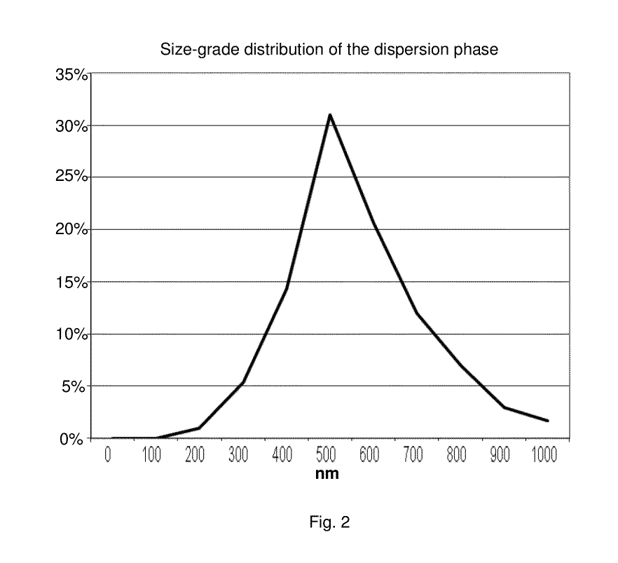

In FIG. 2 it is represented the linear connection of the dispersion phase dimensions for a cosmetic emulsion, obtained with using the channel with two membranes, turned on a frequency of ˜23 khz and ˜40 khz. High intensity of acoustical action took an opportunity to downscale the dimension of the dominant mode of the dispersion phase from 600-700 nanometers, typical for the channel turned to one frequency, up to 500 nanometers, at that the homogenicity level has increased to 30-35% in the discretization interval 100 nanometers.

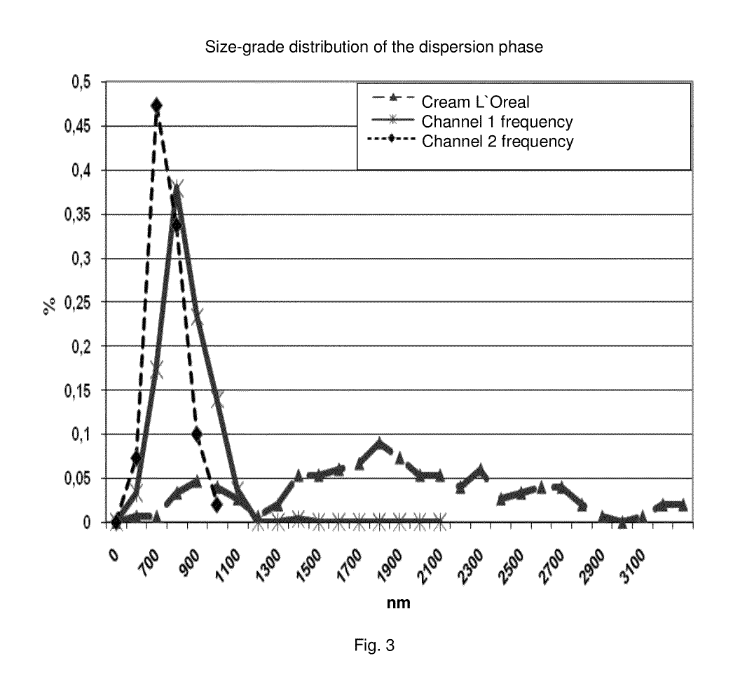

In FIG. 3 it is represented the comparison of size-grade distribution of the dispersion phase of cosmetic emulsion, obtained by different methods of homogeneization—a classic using rotor homogenizers, ultrasonic cavitation in the channel on 1 frequency (prototype), ultrasonic cavitation on 2 frequencies (the applied method).

The implementation of this method at the place of production of DERMANIKA company took the opportunity significantly to increase the efficiency of cavitation effect, to obtain cosmetic emulsion of high quality, to increase the volume of treated liquid ˜2 -2.5 fold, at that the power of ultrasonic generators was reduced from 6 kilowatt to ˜3 kilowatt.

### CITED LITERATURE

1. Bronin F. A. Analysis of cavitation fracture and dispergating of solids in high intensity ultrasonic field. Author's abstract thesis in Engineering Science, MISIS, 1967.

2. Chervyakov V. M., Odnolko V. G. Applying of hydrodynamic and cavitation effects in rotor apparatus.- M. :Izd-vo Mashinistrienye, 2008.

3. Sirityuk M. G. Experimental investigations of ultrasonic cavitation. In the book. Intense ultrasonic field, under the editorship of L. D. Rosenberg , 1968.

4. Krasylnikov V. A. Acoustic and ultrasonic waves in the air, water and solids-M :Fizmatgiz, 1960.

5. Bergman L. Ultrasonics and its application in science and technique.-M. :Inostrannaya literatura, 1956.

6. V. I.Demenko, A. A. Getalov, T. V. Puchkova, E. A. Hotenkova. Effective method impoverishment of emulsifier while production of cosmetic emulsion, magazine “Raw materials and packaging” No 10(101), p.12.

7. Margulis M. A. Fundamental principles of sonochemistry. Chemical reactions in acoustic fields. —M.: Vyshaya Shkola, 1984.

8. Hmelev V. N., Popova O. V. Multifunctional ultrasonic apparatus and their implementation in small productions, agriculture and household conditions; scientific monograph, Alt. Gos. Tekh. Un-t im. I. I. Polzunov.-Barnaul: Izd-vo AltGTU.

9. Koshlyakov N. S.,Gliner E. B., Smimov M. M. Partial equations in mathematical physics. M., Izd-vo Vyshaya shkola, 1970.

10. Armanovich I. G., Levin V. I. Equations of mathematical physics. Second edition, M., Nauka, 1969.

11. Vibrations in technique. Manual in 6 parts, edited by Chalomey V. N., M., Mashinostroenie, 1979.

1. (canceled)

2. A method of ultrasonic cavitation treatment of a liquid medium positioned within a flow channel having a substantially rectangular cross section comprising the steps of:
vibrating a first membrane positioned on a first wall of the flow channel at a harmonic of a fundamental frequency of the first membrane, thereby forming a standing wave on the first membrane;
transferring the vibrations, by at least a portion of the first membrane, to a liquid medium positioned within the flow channel;
vibrating a second membrane positioned on a second wall of the flow channel at a harmonic of a fundamental frequency of the second membrane, thereby forming a standing wave on the second membrane, the harmonic of the fundamental frequency of the second membrane being different from the harmonic of the fundamental frequency of the first membrane;
transferring the vibrations, by at least a portion of the second membrane, to the liquid medium positioned within the flow channel;
optimizing a vibrational amplitude of the first membrane for a desired stage of treatment of the liquid medium such that the amplitude exceeds a threshold of acoustic cavitation of the liquid medium;
optimizing a vibrational amplitude of the second membrane for a desired stage of treatment of the liquid medium such that the amplitude exceeds a threshold of acoustic cavitation of the liquid medium;
selecting the vibrating of the first membrane and the second membrane such that their vibrations transferred to the liquid medium cause the liquid medium to generate quasi-plane standing waves within a clearance of the flow channel between the liquid medium, the quasi-plane standing waves corresponding to the vibrating of the first membrane and the second membrane.

3. The method of claim 2 further comprising the steps of:
activating an piezoelectric ultrasound probe in communication with the liquid medium within the flow channel;
selecting the vibrating frequency and amplitude of the piezoelectric ultrasound probe to cause additional cavitation of the liquid medium.

4. The method of claim 3 wherein the step of vibrating the first membrane comprises vibrating the membrane at a frequency of approximately 23.2 kHz;
wherein the step of vibrating the second membrane comprises vibrating the membrane at a frequency of approximately 40 kHz; and
wherein a power delivered to the ultrasonic wave source is not more than 50 Watt.
